(19) United States
(12) Patent Application Publication
(10) Pub. No.: US 2005/0050075 A1
(43) Pub. Date: Mar. 3, 2005

(54) Data classification processing apparatus, data classification processing method and storage medium

(75) Inventors: Hirofumi Okamoto, Yokohama (JP); Hideyuki Kakutani, Yokohama (JP); Toru Suzuki, Kawasaki (JP); Kazuo Kayamoto, Yokohama (JP); Machiko Ikoma, Yokohama (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 10/881,762

(22) Filed: Jun. 30, 2004

(30) Foreign Application Priority Data
Aug. 29, 2003 (JP) 2003-209637

(51) Int. Cl. G06F 7/00

(52) U.S. Cl. 707/100

(57) ABSTRACT

A data classification processing apparatus assumes that data stored in a database is extracted based on a user instruction. The data classification processing apparatus comprises an information managing unit storing a management point that defines the classification method of the data stored in the database without making the classification method dependent on a particular data item, and an inquiring unit searching the database based on the classification method of the data, which is defined in the management point stored in the information managing unit, in response to a data inquiry from the user.

### BACKGROUND OF THE INVENTION

1. Field of the Invention

The present invention relates to a database search technique, and more particularly, to a technique concerning an OLAP using a data warehouse or a data mart, which stores a large amount of data.

2. Description of the Related Art

A technique called an On-Line Analytical Processing (OLAP) is known as a system that multi-dimensionally analyzes a large amount of data collected by using a data warehouse (hereinafter referred to as a DWH), etc., and visualizes the data. With the OLAP, necessary data is searched in a database with the interactive operation of a user, the searched data is classified from various viewpoints, and its result is output. The OLAP allows a database user to define a sorting rule for a data classification, or to make an inquiry using a defined classification method even if the user doesn't have a special knowledge about a database.

As a technique concerning the OLAP, for example, a technique disclosed by Patent Document 1 exists. With a database system disclosed by Patent Document 1, data within a database and its attribute information are managed by being corresponded to one another, and the data within the database is processed by referencing the attribute information at the request of a user when an inquiry about the data is made, and the processed data is output, so that the operability of the user and the reliability of the data are improved.

With the database system disclosed by Patent Document 1, a sorting rule for a data classification (hereinafter referred to as a classification method) is generated and registered as a management point beforehand, and a general user specifies the management point when making an inquiry about the data within the database, whereby the output format of the data is specified.

FIG. 1 shows the data classification method using the conventional database disclosed by Patent Document 1.

In the system shown in FIG. 1, a database manager first defines and generates the classification method of data as a management point beforehand, and registers the classification method to an information management dictionary. At this time, a system administrator defines a classification method by selecting a data item, which defines the classification method, from an inquiry target table 102 within a DWH 101, and generates a management point 103 ((1) of FIG. 1).

When a general user makes an inquiry about data, he or she first selects a data item to be inquired from the inquiry target table 102 within the DWH 101 ((2) of FIG. 1). When the user specifies an output layout 104 of the data, he or she chooses a management point 103 associated with the data item selected in (2) from a management point list ((3) of FIG. 1).

The system classifies and extracts the data from the DWH 101 based on the classification method specified in the management point selected by the user, and outputs the data based on the specified layout 104.

For such a conventional management point 103 (hereinafter referred to as a category management point) used in a conventional database system, an association with an arbitrary data item in the inquiry target table 102 is determined and defined when the management point 103 is defined. Additionally, a definition made in the management point 102 is effective only for a particular data item within the table 102 of the DWH 101. Accordingly, if a plurality of tables 102 have data items having the same data format, and if the same classification method is desired to be defined for all of the data items, management points must be respectively created for the data items and classification methods must be defined even when the plurality of classification methods are defined from similar viewpoints.

By way of example, if a classification is made for a registration date, a sales date, and a delivery date in a table of sales data of commodities for each quarter, a management point must be provided for each of the data items. Additionally, even when a classification is made by data items having the same registration date, a management point must be provided for each of the tables if target tables are different.

[Patent Document 1]

Japanese Patent Publication No. HEI8-180072

From such a viewpoint, the conventional database has the following problems.
A plurality of definitions must be made even if classification methods of the same data are defined for a plurality of tables including the same data items.
If a plurality of classification methods of the same data are defined, a change operation must be performed a plurality of times when a classification method of data is changed.
Measures cannot be taken if unexpected menu data is added to the database when a management point is defined for a data item.

### SUMMARY OF THE INVENTION

An object of the present invention is to overcome the above described problems.

A data classification processing apparatus according to the present invention assumes that data stored in a database is extracted based on a user instruction, and comprises an information managing unit and an inquiring unit in order to overcome the above described problems.

The information managing unit stores a management point that defines the classification method of data stored in the database without making the classification method dependent on a particular data item.

The inquiring unit searches the database based on the classification method of the data, which is defined in the management point stored in the information managing unit, in response to a data inquiry made by a user.

The data classification processing apparatus may further comprise a function making the user select a data item to which the classification method of data, which is specified by the user and defined in the management point, is applied in response to a data inquiry made by the user, and may be configured to search the database by applying the classification method to the data item selected by the user.

Additionally, the data classification processing apparatus may be configured to further comprise a function registering the classification method, which defines a data item to be classified as a virtual item, as the management point.

Furthermore, a classification processing method and a portable storage medium are covered by a scope to which the present invention is applied.

According to the present invention, since a management point that defines the classification method of data is not dependent on a particular data item, the management point has versatility. Therefore, one management point can be applied to a plurality of data items.

### BRIEF DESCRIPTION OF THE DRAWINGS

FIG. 1 shows a conventional data classification method using a conventional database;

FIG. 2 shows the configuration of a database system according to a preferred embodiment, which is implemented on a server;

FIG. 3 is a block diagram exemplifying the configuration of a data classification processing apparatus;

FIG. 4 shows the basic operations of a system according to a preferred embodiment;

FIG. 5 shows the outline of an operational process and a data flow in the data classification processing apparatus when a category template management point is used;

FIG. 6 exemplifies the configurations of inquiry target tables within a DWH;

FIG. 7 exemplifies the structure of management point information registered in an information management dictionary;

FIG. 8A and 8B are schematics explaining a process for defining a classification method;

FIG. 9 exemplifies screens displayed when a management point is defined;

FIGS. 10A and 10B are schematics explaining a layout specification process executed when a data inquiry is made;

FIG. 11 is a schematic explaining a process for screening applied data items when a selected table has a link relationship;

FIGS. 12 exemplifies screens displayed when a data inquiry is made;

FIG. 13 shows the computer system environment of a server; and

FIG. 14 exemplifies media.

### DESCRIPTION OF THE PREFERRED EMBODIMENTS

Hereinafter, a preferred embodiment according to the present invention is described with reference to the drawings.

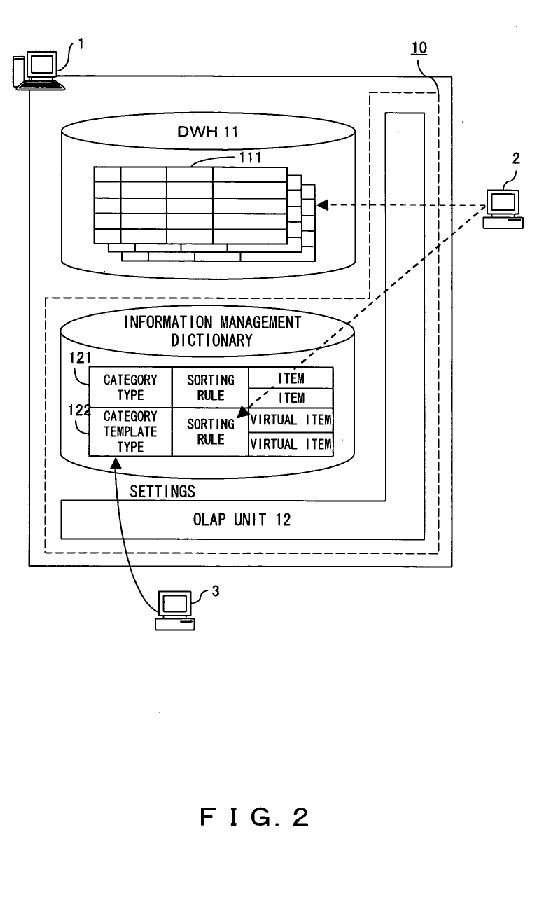

FIG. 2 shows the configuration of a database system according to the preferred embodiment, which is implemented on a server 1.

In this figure, on the server 1, a data classification processing apparatus 10 searching a database based on an instruction from a general user, and outputting classified data, and a DWH 11 that is a database storing various data items from a main system are configured.

The data classification processing apparatus 10 are broadly separated into an OLAP unit 12 classifying and outputting the data within the DWH 11, or executing a process for registering a management point in response to an access made from a terminal 2 of a general user or a terminal 3 of an administrator, which is external to the server 1, and an information management dictionary 13 recording a management point.

The data classification processing apparatus 10 can record the classification method of the data within the DWH 11 as a category template management point 122 in addition to as a conventional category management point 121. For the category template management point 122, its target data item is a virtual item that does not indicate a particular data item. Unlike the category management point 121, the category template management point 122 has a structure that is not dependent on a particular table or a particular data item.

The administrator accesses the server 1 from the terminal 3, creates the classification method of the data within the DWH 11 beforehand without making the classification method dependent on a particular data item by using the data classification processing apparatus 10, and records the created classification method to the information management dictionary 13 as a category template management point 122. If the category template management point 122 is selected when a general user is made to select a management point at the time of an inquiry operation, the general user is made to further select a data item applied to the classification method defined in that management point.

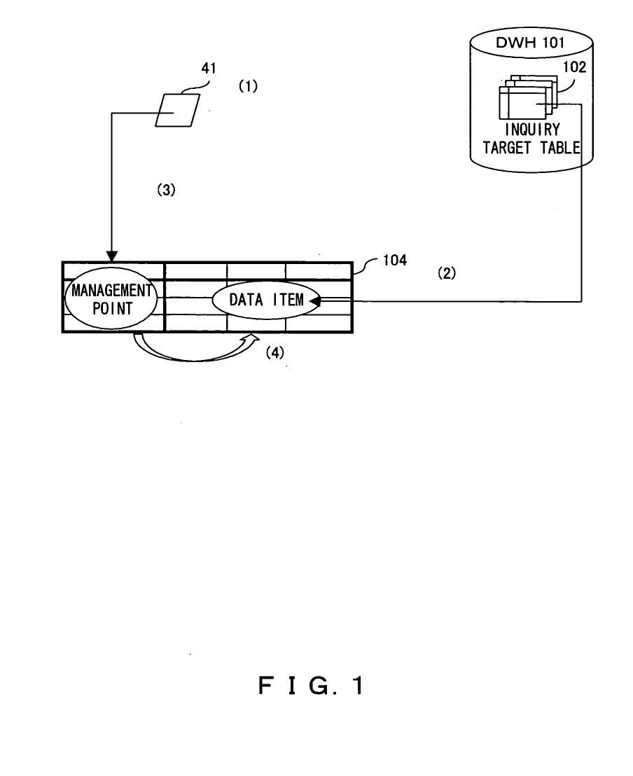

In the system shown in FIG. 2, an operational process executed when the category management point is used is fundamentally the same as that of the conventional system described with reference to FIG. 1. The category template management point will be described in detail later.

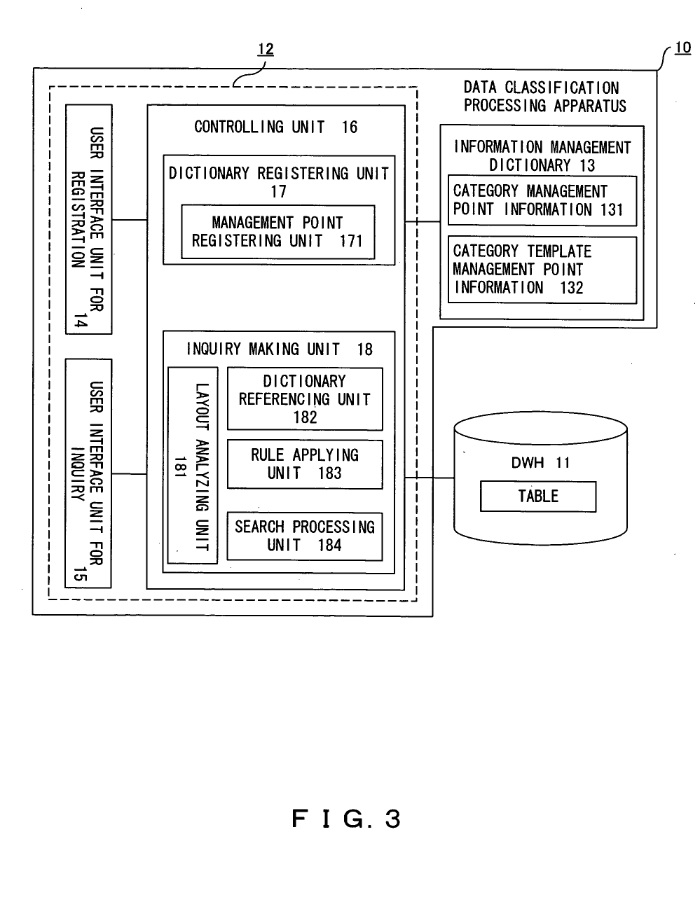

FIG. 3 is a block diagram showing the configuration of the data classification processing apparatus 10.

The data classification processing apparatus 10 shown in this figure comprises an information management dictionary 13, and a user interface unit for registration 14, a user interface unit for inquiry 15, a controlling unit 16, a dictionary registering unit 17, and an inquiry making unit 18, which correspond to the OLAP 12 unit shown in FIG. 2.

The information management dictionary 13 stores the classification method of the data within the DWH 11 as a management point. The information management dictionary 13 shown in FIG. 3 respectively stores a conventional category management point and a category template management point as category management point information 131 and category template management point information 132. For the category management point information 131 and the category template management point information 132, their basic data structures are identical except that the settings of a table and a data item, to which a management point corresponds, are different as will be described later. In the category management point information 131, its associated table and data items are specifically stipulated. In the meantime, in the category template management point information 132, its classification method is registered without stipulating a particular table and/or a particular data item. As a result, the category template management point information 132 has versatility that can be applied to any data item of any table.

The user interface unit for registration 14 implements an interface with the administrator with a GUI, etc. when a management point is registered to the information management dictionary 13. The user interface unit for inquiry 15 implements an interface with a general user with a GUI, etc. when an inquiry about the data within the DWH 11 is made from the terminal 2 of the general user.

The controlling unit 16 registers/updates a management point in the information management dictionary 13 based on an instruction from the terminal 2 of a general user or from the terminal 3 of the system administrator, which is notified from the user interface unit for registration 14 or from the user interface unit for inquiry 15, and communicates with the DWH 11. The controlling unit 16 comprises the dictionary registering unit 17 and the inquiry making unit 18.

The dictionary registering unit 17 executes a process for writing data to the information management dictionary 13, and comprises a management point registering unit 171 registering a management point, and changing an already registered management point. The inquiry making unit 18 executes a process for an inquiry about the data of the DWH 11, which is made from a user. The inquiry making unit 18 searches the DWH 11 based on an instruction from a user, and outputs a result to the terminal 2 of a user based on a layout instructed by the user via the user interface for inquiry 15. The inquiry making unit 18 comprises a layout analyzing unit 181 analyzing the instruction of an output layout, which is made by the inquiry from the user, a dictionary referencing unit 182 reading the management point information 131 and 132 about the management point specified by the user at the time of the inquiry form the information management dictionary 13, a rule applying unit 183 applying the classification method of data to the search in the DWH 11 based on the management point information 131 and 132, which are referenced by the dictionary referencing unit 182, and a search processing unit 184 searching the DWH 11.

With the system according to this preferred embodiment, a classification method is defined by using a management point similar to the conventional system, and a management point is selected when a data inquiry is made, so that the classification method of the data is specified. A category template management point used in this preferred embodiment is not made dependent on a particular data item to be inquired, and created by a creator from his or her unique viewpoint. When an inquiry is made, a classification method defined in the category template management point is associated with a particular table or particular data item to be inquired at the time of the inquiry.

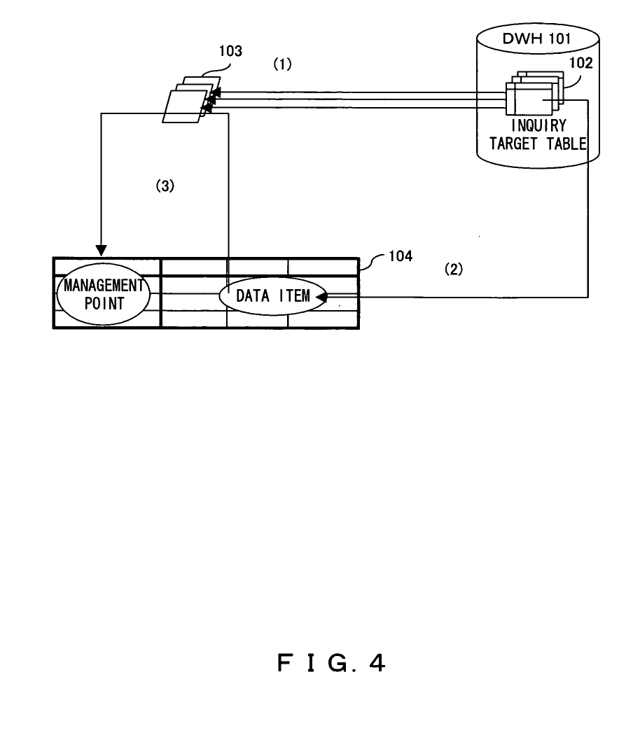

FIG. 4 shows the basic operations performed by the system according to this preferred embodiment. This figure is illustrated in contrast with the conventional system shown in FIG. 1. Constituent elements, which fundamentally have the same functions as those in FIG. 1, are denoted with the same reference numerals. Additionally, since an operational process using a category management point is fundamentally the same as that shown in FIG. 1, only the case where a category template management point is used is shown in FIG. 4.

In FIG. 4, the system administrator first defines the classification method of data as a category template management point 41 beforehand by using the data classification processing apparatus, and stores the management point in the information management dictionary. At this time, the system administrator defines the classification method from his or her unique viewpoint without making the classification method dependent on a particular data item in a particular table within the DWH 101 ((1) of FIG. 4).

When a general user makes a data inquiry, he or she first selects a data item to be inquired from the inquiry target table 102 within the DWH 101 at the time of specifying the output layout 104 of the data ((2) of FIG. 4).

Next, the general user selects a template management point to be used ((3) of FIG. 4). Then, the management point selected in (3) is associated with a data item within the same table as that of the data item selected in (2) ((4) of FIG. 3).

As described above, for the category template management point, its associated data item is selected when a general user specifies a management point and the output layout of data not at the time of the definition of the management point but at the time of the data inquiry made by the general user. Accordingly, since a data item associated with a management point is not identified from the contents of definition made in the management point, one management point can be used for a plurality of data items or tables in a versatile manner. Additionally, a data item associated with the definition of a management point is specified when a data inquiry is made, whereby measures can be taken even if the data of an unexpected data item is added to the DWH 101 beforehand.

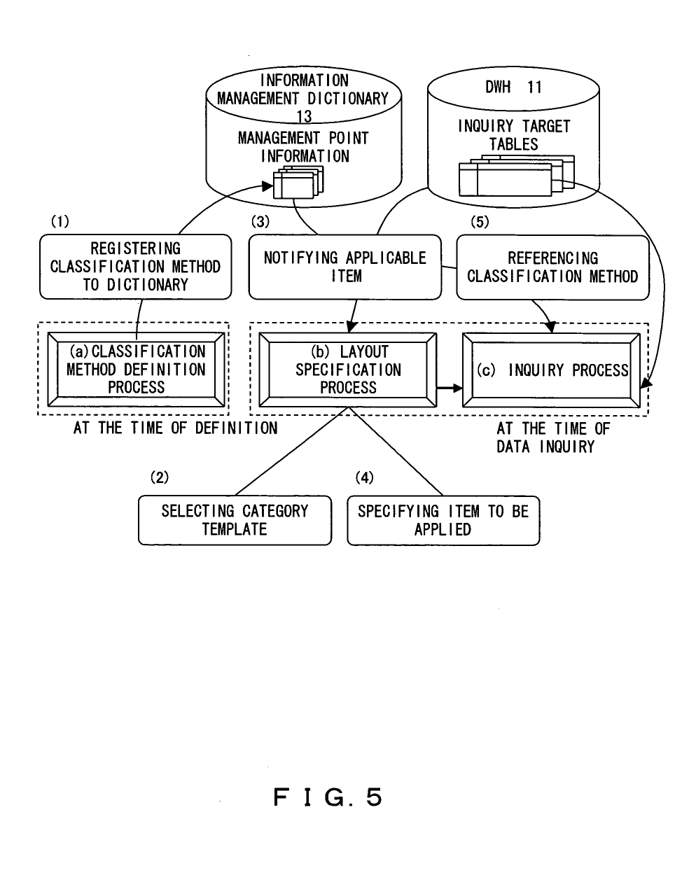

FIG. 5 explains the outline of an operational process and a data flow in the system implemented when a category template management point is used. (1) to (5) used in the following description respectively correspond to (1) to (5) shown in FIG. 5.

at the time of definition

(a) a classification method definition process
(1) A classification method that is not dependent on a particular data item is defined, and registered to the dictionary. The registered classification method is managed in the information management dictionary 13 as a category template management point.

How to define a classification method is made by including a creation source item in information registered to the dictionary for a conventional category management point. However, in the category template management point, information about a creation source item is defined as a virtual item name that does not indicate a particular data item. As a result, the category template management point is not dependent on a particular table or a particular data item.

at the time of data inquiry

(b) a layout specification process
(2) On a screen for specifying the output layout of data, a general user specifies a category template management point.
(3) Data items to which the category template management point specified in (2) is applicable are extracted from an inquiry target table, and notified to the general user.
(4) The user selects a data item, to which a classification method possessed by the category template management point selected in (2) is applied, from among the data items notified in (3).
(c) an inquiry process
(5) Classification information defined in the category template management point selected in (2) is extracted from the information management dictionary 13, and information is collected from the data item within the inquiry target table, to which the category template management point is applied in (4), and output.

How to manage information about a management point within the information management dictionary 13 when a category management point and a category template management point are defined are described next.

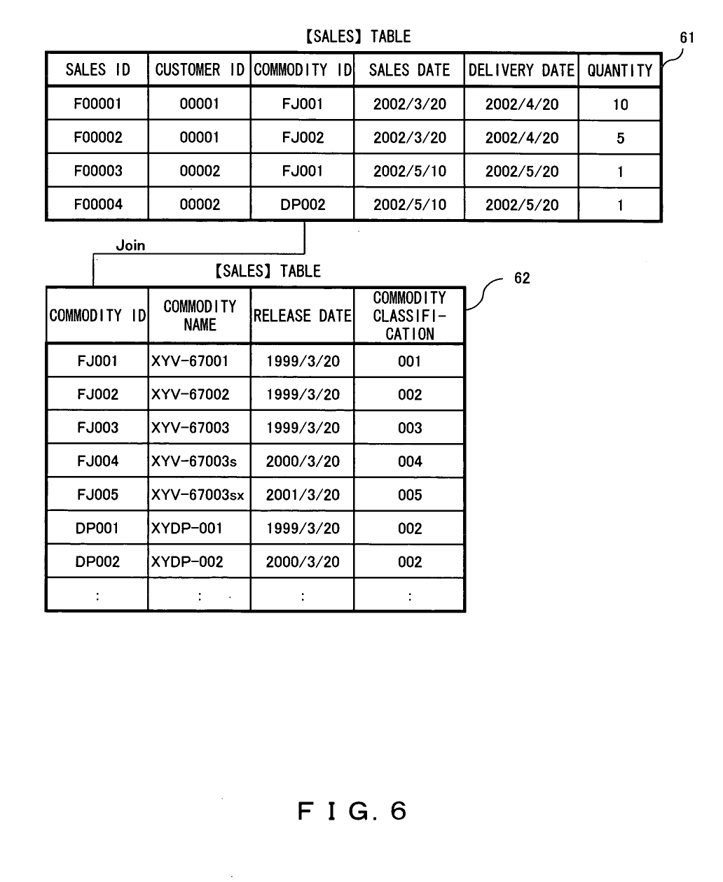

FIG. 6 exemplifies the configurations of tables within the DWH 11. The tables shown in this figure become inquiry target tables when an inquiry is made.

This figure shows, as examples, a sales table 61 that records sales information, and a commodity table 62 that records information about each target commodity in the sales table 61 as tables within the DWH.

To the sales table 61, a sales ID for identifying a sales transaction, a customer ID for identifying a customer, a commodity ID for identifying a commodity, a sales date, a delivery date, and a sales quantity are recorded as data items. To the commodity table 62, a commodity ID for identifying each commodity, the name of the commodity, a release date, and a classification number indicating the classification of the commodity are recorded as date items. These data items are associated with the data within the sales table 61 by the commodity ID.

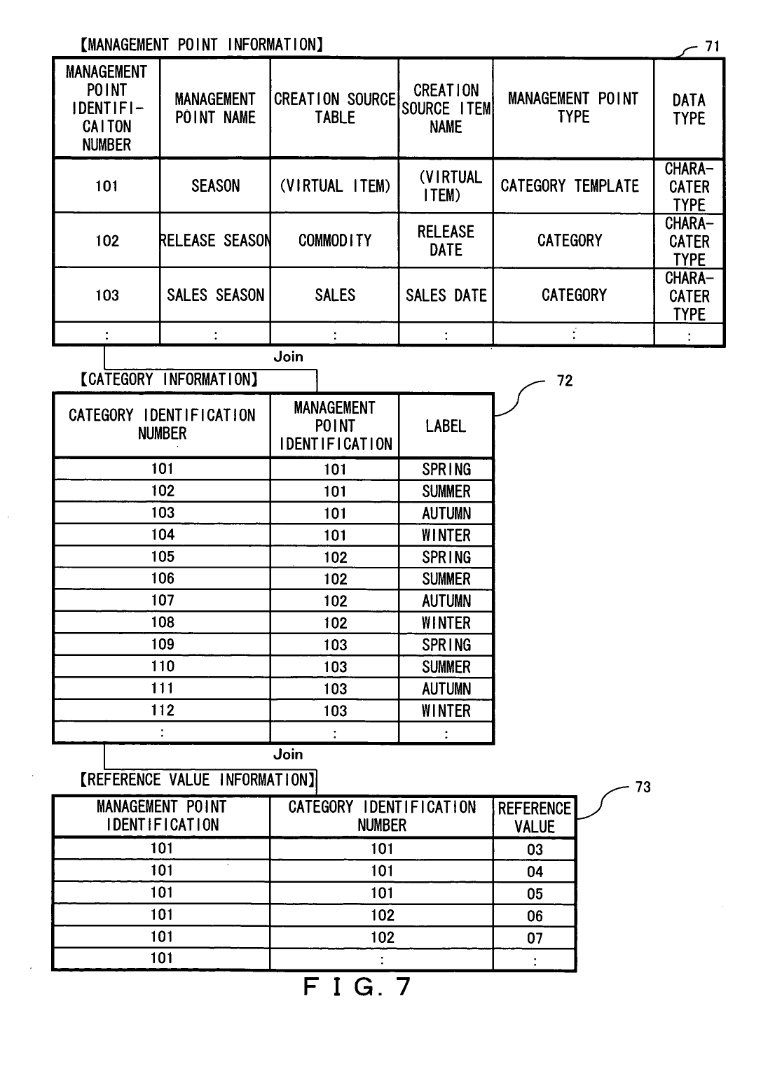

A category management point, which can be used to define a data classification when the tables shown in FIG. 6 are used as inquiry target tables, becomes the one shown in FIG. 7.

FIG. 7 exemplifies the structure of the management point information 131 and 132, which define the management point defining the classification of the tables that are shown in FIG. 6 and registered to the information management dictionary 13.

This figure exemplifies the structure of a management point for classifying the data of the tables shown in FIG. 6 by four classification categories “spring”, “summer”, “autumn”, and “winter” with the use of the data of a data item having a date data format.

This figure shows management point information 71 that defines the information of a management point itself, category information 72 that defines a classification category classified by a management point, and reference value information 73 that defines a numerical value range classified by each classification category. With these information items, each management point is defined.

To the management point information 71 shown in FIG. 7, an identification number, a management point name, a creation source table indicating an inquiry target table to be targeted, a creation source item name indicating a target data item, the type of a management point, the data type of a target data item, and a sorting rule not shown are recorded as information about each management point. Since this example is the management points for the classification by season, for example, a classification rule such as “extracting the sixth and seventh digits of the date data of the creation source item, and comparing with a reference value”, or the like is recorded as the sorting rule. The management point information 71 is associated with a classification category registered to the category information 72 based on the identification number for identifying each registered management point.

The category information 72 defines a category for classifying data. To the category information 72, a category identification number for identifying each classification category, an identification number indicating which management point each classification category indicates, and a label that allows a user to recognize the contents of the classification category are recorded. The respective data within the category information 72 are associated with the reference value information 73 by the category identification number, and with the management point information 71 by the management point identification number.

For the reference value information 73, a numerical value range for making a classification by each classification category defined in the category information 72 is defined as a reference value. A classification is made based on this value and the sorting rule of the management point information 71. The reference value information 73 is associated with the management point information 71 by the management point identification number, and with the category information 72 by the category identification number.

The classification method of a management point is defined by these information items. By way of example, for a management point having a management point identification number 102, a definition such that the data of the data item “release date” in the commodity table 62 in FIG. 6 is classified into four classification categories such as “spring”, “summer”, “autumn”, and “winter” is made. A value obtained by processing the data of the data item “release date” based on the sorting rule is compared with the value registered to the reference value information 73, whereby the data is classified into the classification categories such as “spring”, “summer”, “autumn”, and “winter”.

Among the three management points having the identification numbers 101 to 103 shown in FIG. 7, the management points having the identification numbers 102 and 103 are conventional category management points, and the management point having the identification number 101 is a category template management point as indicated by the management point type of the management point information 71.

Comparing between the management point information 71 of the category management point and that of the category template management point in FIG. 7, a particular table and a particular data item are defined in two data items such as the creation source table and the creation source item name in the category management point, while virtual items are defined as the table and the item in the category template management point. For the conventional category management point, its creation source item is determined at the time of creation, and respective information items are managed by the management point information 71 in the information management dictionary 13. For the category template management point, its creation source item information is not managed by the management point information 71 in the information management dictionary 13, and selected by a general user in the stage of an actual use. As a result, the category template management point can possess versatility, and can cope with a plurality of tables.

Each process executed when the category template management point shown in FIG. 7 is used is further described in detail next.

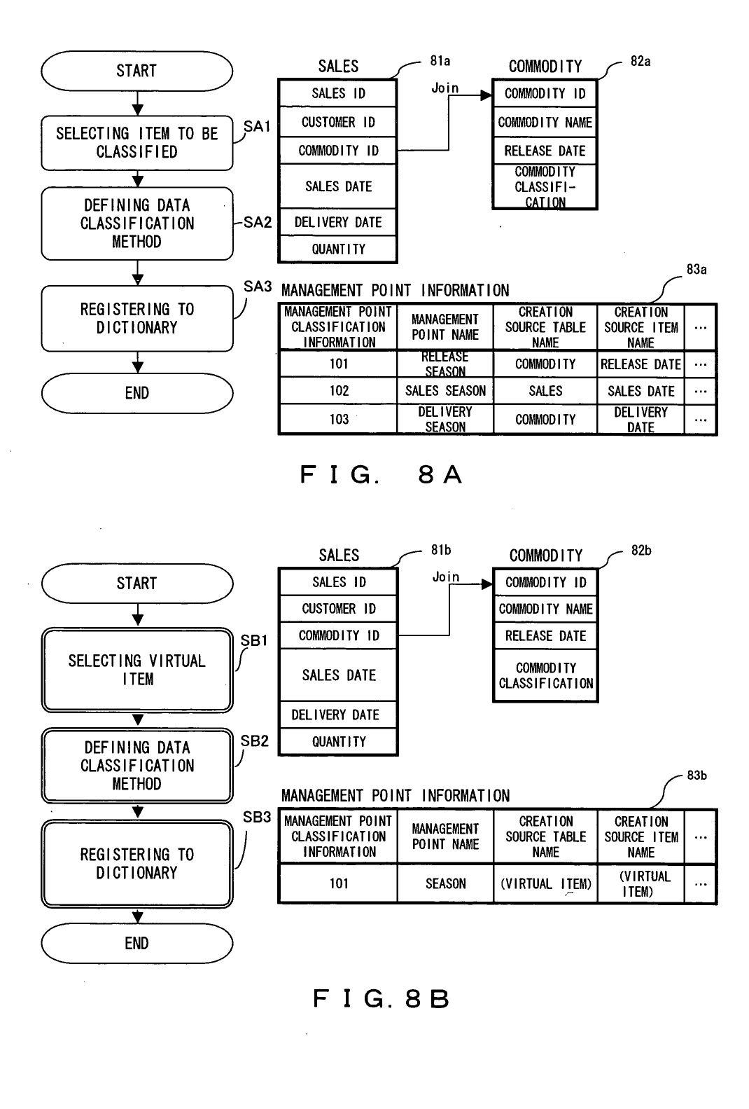

FIGS. 8A and 8B are schematics explaining a process for defining a classification method.

FIG. 8A shows the case of a category management point, whereas FIG. 8B shows the case of a category template management point, which corresponds to “(a) the classification method definition process” shown in FIG. 5.

In the case of the category management point, a classification method is defined in the information management dictionary 13 with procedures represented by a flowchart shown in FIG. 8A.

Firstly, a user who makes a definition is made to select a data item to be classified as step SA1. Then, as step SA2, a data classification method is defined based on a selection of the user. For the category management point, a data item to be classified must be selected when the classification method is defined.

Lastly, the definition of the classification method is registered to the information management dictionary 13 as a management point as step SA3.

For the category management point, a classification method must be defined for each data item to be classified. By way of example, if data items “sales date” and “delivery date” in a sales table 81a, and a data item “release date” in a commodity table 82a are information indicating a date having the same format, and if a classification method that classifies the respective data items by season is defined, the same definition must be made three times to create three management points. In the case of FIG. 8A, a management point is provided and registered for each of the “sales date”, the “delivery date”, and the “release date” in the management point information 83a.

In the meantime, in the case of the category template management point, a classification method is defined in the information management dictionary 13 with procedures represented by a flowchart shown in FIG. 8B.

Firstly, a virtual item is selected on demand as a data item to be classified as step SB1. Then, as step SB2, a data classification method is defined. For the category template management point, there is no need to select a data item to be classified when a classification method is defined. Accordingly, the management point can be defined not only a system administrator who is thoroughly familiar with the data structure of the database but also a general user. If many classification methods are defined, a selection may be made from among prepared samples in order to reduce the load of operations.

Upon completion of a definition input, the management point is registered to the information management dictionary 13 as step SB3.

For the category template management point, a defined classification method can be applied to a data item when an inquiry is made. This eliminates the need for defining a classification method for each data item having the same format. For example, the data items “sales date” and “delivery date” in the sales table 81b, and the data item “release date” in the commodity table 82b are information indicating a date having the same format, and if a classification method which classifies these data items by season is defined, it is sufficient to define one category template management point. In the case of FIG. 8B, only one category template management point the name of which is “season” is defined and registered in the management point information 83b. By defining a creation source table and a creation source item name, which are virtual items, with this management point when a data inquiry is made, the data items “sales date”, “delivery date”, and “release date” in the above described tables can be coped with.

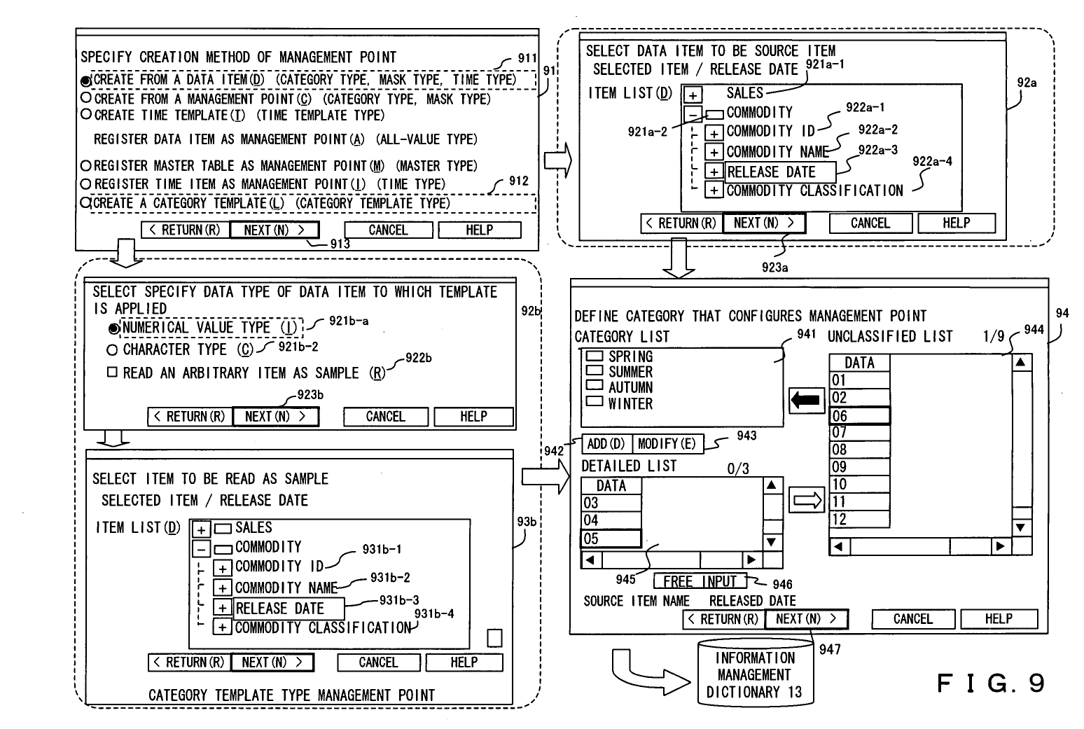

FIG. 9 exemplifies screens displayed when a management point is defined. This figure exemplifies the screens displayed on the terminal 3 of the system administrator who is to define a management point.

Once the system administrator starts the process for defining a management point, a screen 91 is first displayed on the terminal 3 of the system administrator.

The system administrator selects “create from a data item” 911 if the management point to be created on the displayed screen is a category management point, or selects “create a category template” 912 if the management point to be created is a category template management point. The system administrator then presses a “next” button 913 to switch the display.

If “create from a data item” 911 is selected on the screen 91, the display switches to a category management point creation screen 92a. On this screen 92a, a data item 92a for defining an inquiry target table 921a and a classification method is selected. In this figure, a “commodity” 921a-2, and a “release date” 922a-3 are respectively selected as the inquiry target table and the data item.

After the data item 922 for defining the inquiry target table 922a and the classification method is selected, the system administrator presses a “next” button 923a to switch to a classification information definition screen 94.

If “create a category template” 912 is selected on the screen 91, the display switches to a category template management point creation screen 92b. On this screen 92b, a data type 921b of a data item to be targeted by the management point is specified. In the case of FIG. 9, a selection is made from among two data types such as a numerical value type 921b-1 and a character type 921b-2 as a data type, and a “next” button 923b is pressed to switch to the classification information definition screen 94.

Additionally, if an arbitrary data item is used as a sample when a classification method is defined, a “read an arbitrary item as a sample” field 922b on this screen 92b is checked, and the “next” button 923b is pressed, so that a selection screen 93b for the data item of the sample is displayed. On the selection screen 93b, data items 931b available as the sample are displayed based on the data format selected on the screen 92b. The “next” button 932b is pressed after a suitable item is selected from among the data items 931b, so that the display switches to the classification information definition screen 94.

On the classification information definition screen 94, a category that configures the management point is defined.

On the classification information definition screen 94, a category is defined in a way such that a category is created by operating an add button 942 or a modify button 943 on a category list 941, data within an unclassified list 944, which displays a list of range values taken by the data of the data item selected on the screen 92a or the data of the data item of the sample selected on the screen 93b, is moved to a detailed list field 945 after one category is selected from the category list 941. If the data item of the sample is not read for the category management point, no data items are displayed in the unclassified list 944, and a definition for each category must be made by operating “a free input” button 946 to input all of values.

When a “next” button 947 is pressed after the input of the definition of classification information for each category is completed, the management point based on the input definition is recorded to the information management dictionary 13.

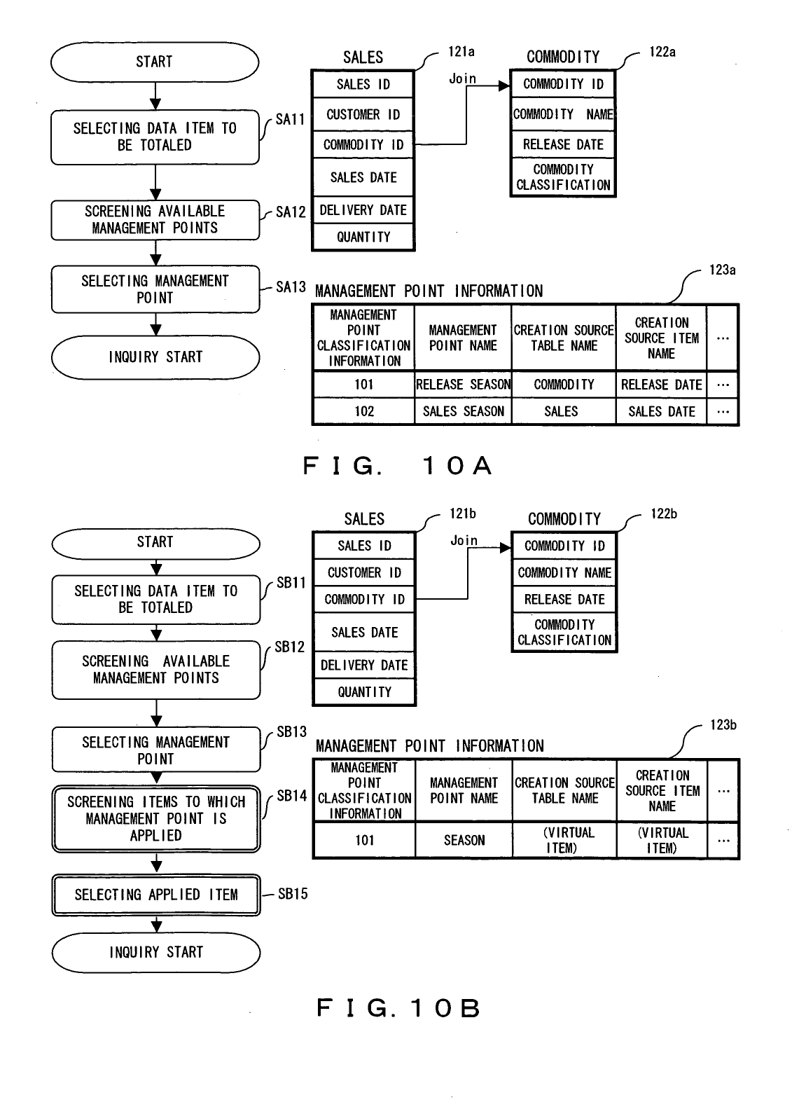

FIGS. 10A and 10B are schematics explaining a layout specification process executed when a data inquiry is made. FIG. 10A shows the case of the category management point, whereas FIG. 10B shows the case of the category template management point and corresponds to the “(b) the layout specification process” shown in FIG. 5.

In the case of the category management point, the output layout of data to be inquired is specified with procedures represented by a flowchart shown in FIG. 10A.

Firstly, as step SA11, a general user is made to select a data item to be totaled. Then, as step SA12, the data classification processing apparatus 10 screens management points available to the data item selected by the general user in step SA11, and lists and displays the screened management points for the general user. Then, the general user is made to select from among these management points as step SA13.

If the general user selects a data item to be totaled when specifying the output layout as step SA11, the data classification processing apparatus 10 automatically screens available management points when totaling the data item. An example of a method of this screening is as follows. The data classification processing apparatus 10 screens a management point having a management point identification number “101” and a management point name “release season” as an available management point if a data item “commodity ID” in a commodity table 122a is selected as a data item to be totaled in step SA11.

By a screening rule at this time, a management point created from a data item in the table to which the selected data item belongs (the management point that registers the table to which the selected data item belongs as a creation source table), or the management point created from a data item in the table with which the table to which the selected data item belongs is associated (the management point that registers as a creation source table the table associated with the table to which the selected data item belongs) is screened as an available management point. A category template management point in which the creation source table and the creation source item name are virtual items is selected unconditionally in this screening.

When the user selects a suitable category management point from among the screened management points, the data classification processing apparatus 10 starts an inquiry process, applies a classification method defined in the selected management point, and searches the DWH 11.

In the meantime, in the case of the category template management point, the output layout of data to be inquired is specified with procedures represented by a flowchart shown in FIG. 10B.

Firstly, a general user is made to select a data item to be totaled as step SB11. Then, as step SB12, the data classification processing apparatus 10 screens management points available to the data item selected by the general user, and lists and displays the screened management points for the general user. As step SB13, the general user is made to select from among the screened management points. Steps SB11 to SB13 are the same as steps SA11 to SA13 in the case of the category management point shown in FIG. 10A.

Here, if the general user selects the category template management point, the data classification processing apparatus 101 lists and displays screened items after screening the items to which the management point is applied as step SB14. Then, as step SB15, the general user is made to select an applied item.

If the general user selects the category template management point as a classification method when specifying the output layout of the data after selecting a data item to be totaled, the data classification processing apparatus 10 screens data items to which the selected management point can be applied, and lists and displays the screened data item for the general user.

For example, if a “commodity ID” in a commodity table 122b is selected as a data item to be totaled in step SB11, and if a management point having a management point identification number “101” and a management point name “season” in management point information 123b is selected in step SB13, data items “sales date” and “delivery date” in a sales table 121b, and data items “commodity name” and “release date” in a commodity table 122b are screened as candidates of data items to which the management point can be applied in the screening in step SB14. By a screening rule at this time, screened are a data item in the table to which the selected data item belongs, or in a table associated with the table to which the selected data item belongs, and the data item of a data type (character type in this example), to which the category template management point can be applied.

When the general user selects a data item, to which the management point is applied, from among the displayed data items, the data classification processing apparatus 10 reads a classification method defined in the selected management point from the information management dictionary 13 as a process corresponding to (c) the inquiry process shown in FIG. 5, searches the DWH 11 by applying the read classification method, and outputs a result of the search to the general user based on the specified layout.

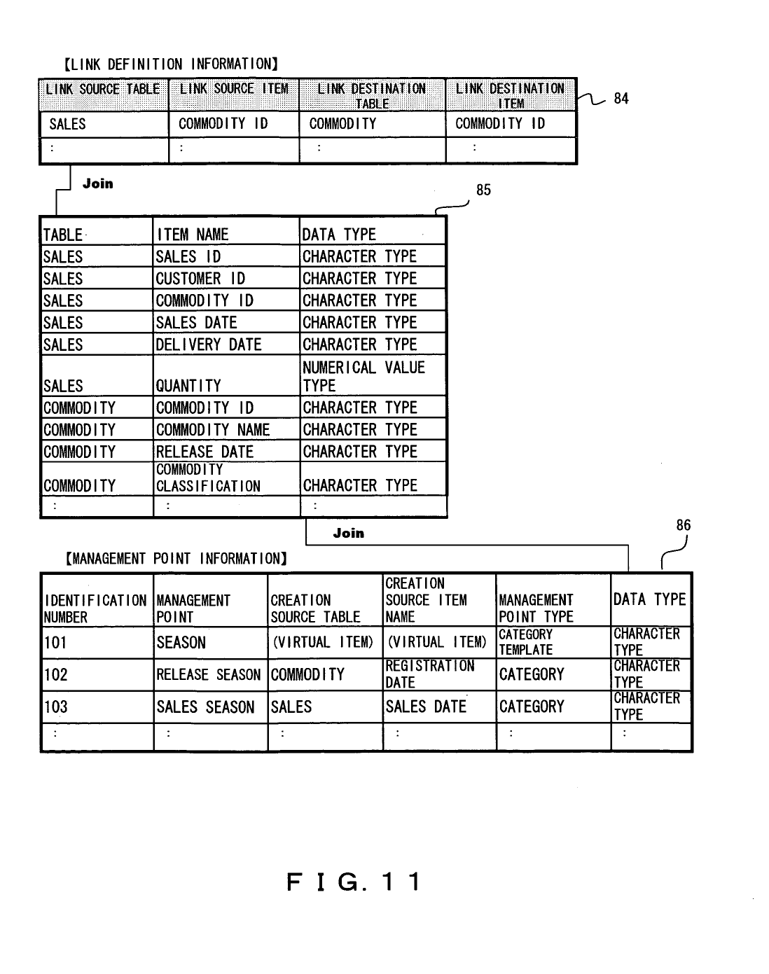

FIG. 11 explains the process for screening an applied item, which is executed when a selected table has a link relationship. This process corresponds to step SB14 of FIG. 10.

When a general user selects a category template management point, the data classification processing apparatus 10 displays selection candidates and makes the general user select an applied item after screening items to which the management point is applied. However, if the table to which the data item selected in step SB11 belongs has a link relationship with another table, this screening process is executed as follows.

In FIG. 11, link definition information 84 is information indicating a link relationship among respective tables, and stores the name of a link source table and item names within the table by associating with the name of a link destination table and item names within the table. Table information 85 manages the name of each table, item names within each table, and the data types of the items.

If the table to which the data item selected in step SB11 belongs does not have a link relationship with another table, or if the table is not a link source even though it has a link relationship, the screening process in step SB14 is executed by targeting only the table to which the selected data item belongs.

For example, if an item “commodity name” in a commodity table is selected, and if a management point having a management point identification number “101” and a management point name “season” is selected from the management point information in FIG. 11, items screened as items to which the management point is applied in step SB14 are items such as “commodity ID”, “commodity name”, “release date”, and “commodity classification”, which are of the same data type (character type) as that specified as the management point within the same commodity table.

In the meantime, if the table to which the data item selected in step SB11 has a link relationship with another table and the table is a link source, in the link definition information 84, the screening process in step SB14 is executed by targeting also a link destination table in addition to the table to which the selected data item belongs.

For example, if an item “quantity” in the sales table is selected, and if the management point having the management point identification number “101” and the management point name “season” is selected from the management point information in FIG. 11, items screened as items to which the management point is applied in step SB14 are items such as “sales ID”, “customer ID”, “commodity ID”, “sales date”, “delivery date”, “commodity ID”, “commodity name”, and “release date”, which are of the same data type (character type) as that specified as the management point within the sales table or the commodity table which is a link destination table of the sales table.

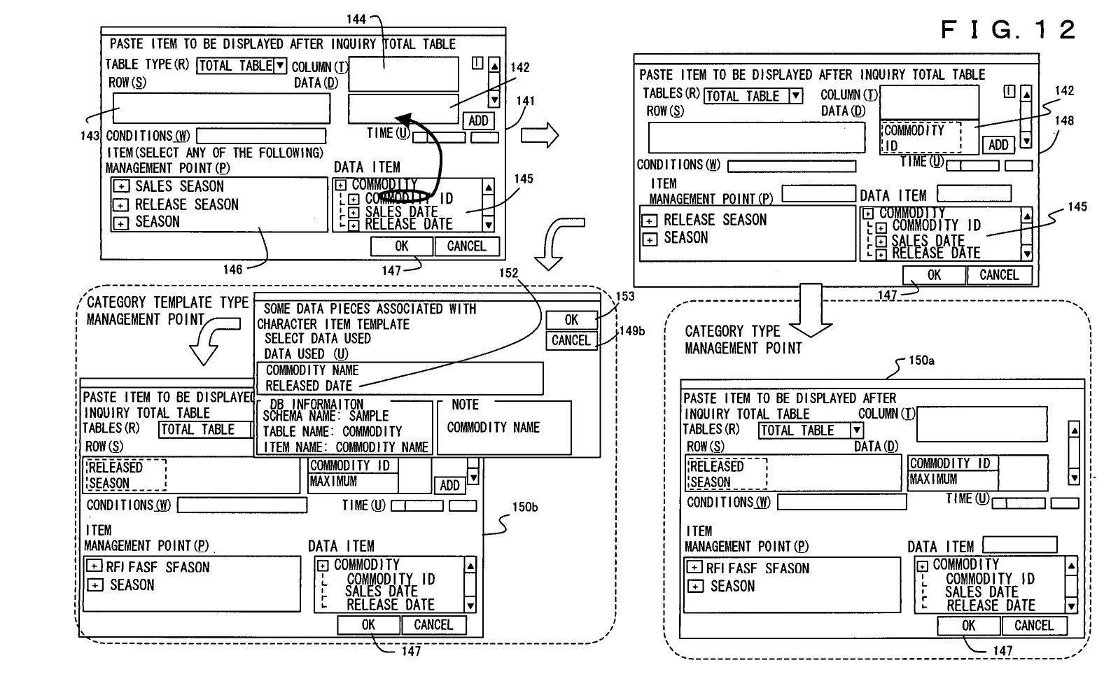

FIG. 12 exemplifies screens displayed when a data inquiry is made. This figure exemplifies the screens displayed on the terminal 2 of a general user when he or she makes an inquiry about the data within the DWH 11.

When the general user starts the data inquiry, a screen 141 is first displayed on the terminal 2 of the general user.

This screen 141 is a screen for setting an output layout intended to output data as a total table. In this figure, an input field 142 is a field for specifying the data item of target data, an input field 143 is an input field for specifying a data item that becomes each row of the total table, and an input field 144 is an input field for specifying a data item that becomes each column of the total table. After a general user specifies the data item of target data in the input field 142 on this screen 141, he or she specifies a management point in the input fields 143 and 144 for each row and column, so that the classification method and the output layout of the data are instructed.

On the display screen 141, the general user first selects a data item to be totaled from the data item field 145 and sets the selected item in the input field 142 as the process for selecting a data item, which corresponds to step SB11 of FIG. 10B. In this figure, the data item “commodity ID” in the commodity table is selected and set in the data field 142.

When the data item to be totaled is specified, the display switches to a screen 148, on which the general user specifies a data item to become the column and/or the row of the total table to be output.

The item to become the row or the column is specified by selecting from among the management points displayed in a display field 146, and by inputting the selected management point in the input fields 143 and 144. In this display field 146, management points applicable to the data item set in the input field 142 are screened and displayed. In this figure, three management points are displayed in the display field 146 on the screen 141. However, on the screen 148 where the data items are set in the input field 142, a management point “sales season” disappears as a result of executing the screening process corresponding to steps SA12 and SB12 of FIG. 10.

If the output layout of the total table is set by selecting one of the management points displayed in the display field 146 and by setting the selected management point in the input fields 143 and 144 on the screen 148, the display of the terminal 2 of the general user switches to a screen 150a if the selected management point is a category management point, or switches to a screen 150b if the selected management point is a category template management point.

If the selected management point is a category management point, with the press of an OK button 147 on the display screen 150a, the data classification processing apparatus 10 searches the DWH 11 for the data based on the set condition, and outputs a result based on the specified layout to the terminal 2 of the general user.

Or, if the selected management point is a category template management point, a data item to which the management point is applied must be set. Therefore, the process for screening a data item, which corresponds to step SB14 of FIG. 10, is executed and a candidate data item is displayed on a selection screen 149b for a data item. After a data item to which the management point is applied is selected from a candidate list 152, an OK button 153 is pressed to set the data item.

When the layout specification is completed with the press of the OK button 147 on the switched display screen 150b, the data classification processing apparatus 10 searches the DWH 11 based on a classification method set in the selected management point, and outputs a result of the search to the terminal 2 of the general user based on the specified layout.

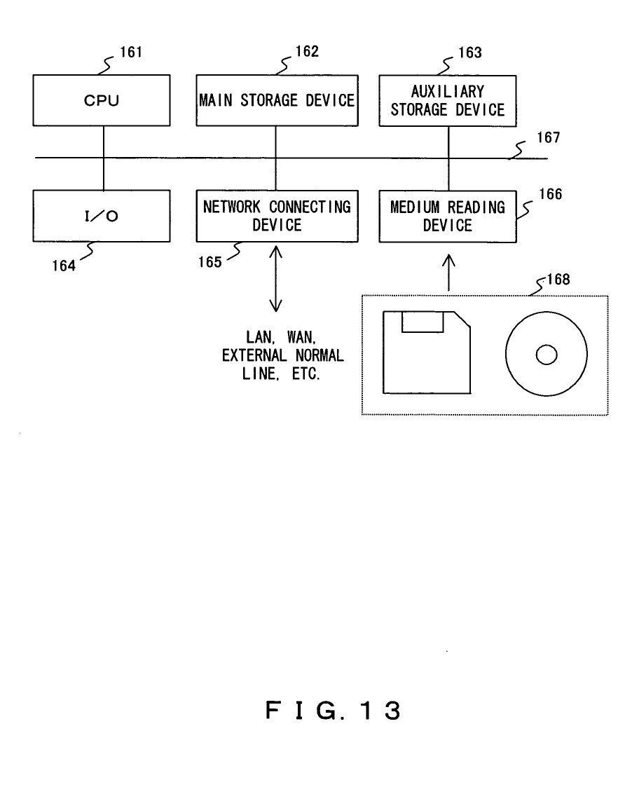

FIG. 13 shows the computer system environment of a server 1.

The server 1, on which the data classification processing apparatus 10 according to this preferred embodiment is implemented, comprises a CPU 161, a main storage device 162, an auxiliary storage device 163 such as a hard disk, etc., an input/output (I/O) device 164 such as a display, a keyboard, etc., a network connecting device 165 such as a modem, etc., and a medium reading device 166 reading stored contents from a portable storage medium such as a disk, a magnetic tape, etc. These constituent elements are interconnected by a bus 167.

In the computer system shown in FIG. 13, a program and/or data stored onto a storage medium 168 such as a magnetic tape, a flexible disk, a CD-ROM, an MO, etc. are read by the medium reading device 166, and downloaded into the main storage device 162 and/or the auxiliary storage device 163. Based on this program and/or data, the CPU 161 implements the above described functions of the data classification processing apparatus 10 such as building the information management dictionary 13 in the main storage device 162 or the auxiliary storage device 163, communicating with a user, creating a management point, searching the DWH 11, etc.

Additionally, in the computer system shown in FIG. 13, there may be cases where application software is replaced by using the storage medium 168 such as a flexible disk, etc. Accordingly, the present invention is not limited to the data classification processing apparatus or method. The present invention can be configured also as a computer-readable storage medium 168 for causing a computer to execute the above described functions of the preferred embodiment according to the present invention when being used by the computer.

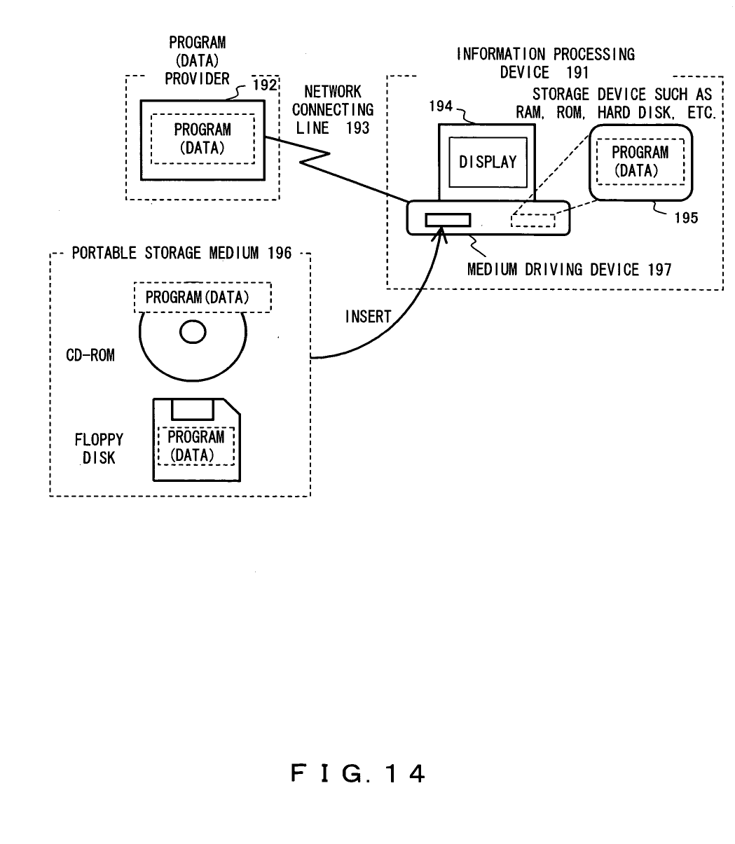

In this case, as shown in FIG. 14, examples of the storage medium include a portable storage medium 196 such as a CD-ROM, a flexible disk (or an MO, a DVD, a removable hard disk, etc.), which can be inserted/removed in/from a medium driving device 197, a storage unit 192 (database, etc.) within an external device (server, etc.) to which the program and/or the data are transmitted via a network line 193, a memory (a RAM, a hard disk, etc.) 195 within a main body 194 of an information processing device 191, and the like. The program stored on the portable storage medium 196 or in the storage unit 192 (database, etc.) is loaded into the memory (a RAM, a hard disk, etc.) within the main body 194 and executed.

The present invention can be also implemented by using various types of large-capacity storage media developed already and henceforth, for example, a next-generation optical disc storage medium using blue laser, such as a Blu-ray Disc (registered trademark), an AOD (Advanced Optical Disc), etc., an HD-DVD9 using red laser, a Blue Laser DVD using blue violet laser, etc. in addition to the above cited storage media such as a CD-ROM, a DVD-ROM, etc.

According to the present invention, versatility can be imparted to the registration of the definition of a classification method, whereby the definition of a classification method of the same purpose can be made only once.

Additionally, a plurality of data classification methods of the same purpose can be defined with one definition, so that only one definition change is required even when a classification method is changed.

Furthermore, the number of definitions of classification methods can be reduced, whereby a load on a system administrator can be lightened.

Still further, also a data addition to the database can be flexibly coped with.

Still further, maintenance is easy, so that the definition of a new classification method, etc. can be quickly made, and not only a system administer but also a general user can find it easier to use the system.

1. A data classification processing apparatus extracting data stored in a database based on an instruction of a user, comprising:
an information managing unit storing a management point that defines a classification method of the data stored in the database without making the classification method dependent on a particular data item; and
an inquiring unit searching the database based on the classification method of the data, which is defined in the management point stored in said information managing unit, in response to a data inquiry from the user.

2. A data classification processing apparatus extracting data stored in a database based on an instruction of a user, comprising:
information managing means for storing a management point that defines a classification method of the data stored in the database without making the classification method dependent on a particular data item; and
inquiring means for searching the database based on the classification method of the data, which is defined in the management point stored in said information managing means, in response to a data inquiry from the user.

3. A data classification processing method extracting data stored in a database based on an instruction of a user, comprising:
storing a management point that defines a classification method of the data stored in the database without making the classification method dependent on a particular data item; and
searching the database based on the classification method of the data, which is defined in the stored management point, in response to a data inquiry from the user.

4. The data classification method according to claim 3, further comprising making a user select a data item to which the classification method of the data, which is defined in the management point specified by the user, in response to a data inquiry from the user, and, wherein the searching process searches the database by applying the classification method to the data item selected by the user in response to a data inquiry from the user.

5. The data classification method according to claim 4, further comprising screening candidates of the data item, to which the classification method of the data defined in the management point specified by the user can be applied, based on a data item to be inquired, notifying the user of the candidates, and, wherein the making process makes the user select from among the candidates.

6. The data classification method according to claim 5, wherein
the notifying process notifies, as the candidates, a data item in a same table as the data item to be inquired, and a data item in a table having a link relationship with the same table.

7. The data classification method according to claim 3, further comprising
outputting a result of the search based on a layout specified by the user.

8. The data classification method according to claim 3, further comprising
registering the classification method, which defines a data item to be classified as a virtual item, as the management point.

9. The data classification method according to claim 3, wherein
the management point defines the classification method of the data stored in the database without making the classification method dependent on a particular table and a particular data item in the database.

10. The data classification method according to claim 3, wherein
the management point is defined by management point information that records a name of the management point and a data type of a data item to which the management point is applied, category information that defines a classification category classified by the management point, and reference value information that defines a numerical value range classified by each classification category.

11. A computer-readable portable storage medium on which is recorded a program, when used by a computer extracting data stored in a database based on an instruction of a user, for causing the computer to execute a process, the process comprising:
storing a management point that defines a classification method of the data stored in the database without making the classification method dependent on a particular data item; and
searching the database based on the classification method of the data, which is defined in the stored management point, in response to a data inquiry from the user.

12. The computer-readable portable storage medium according to claim 11, the process further comprising making a user select a data item to which the classification method of the data, which is defined in the management point specified by the user, in response to a data inquiry from the user, and wherein the searching process searches the database by applying the classification method to the data item selected by the user in response to a data inquiry from the user.

13. The computer-readable portable storage medium according to claim 12, the process further comprising
screening candidates of the data item, to which the classification method of the data defined in the management point specified by the user can be applied, based on a data item to be inquired, notifying the user of the candidates, and wherein the making process makes the user select from among the candidates.

14. The computer-readable portable storage medium according to claim 13, the process further comprising
notifying, as the candidates, a data item in a same table as the data item to be inquired, and a data item in a table having a link relationship with the same table.

15. The computer-readable portable storage medium according to claim 11, further comprising
outputting a result of the search based on a layout specified by the user.

16. The computer-readable portable storage medium according to claim 11, the process further comprising
registering the classification method, which defines a data item to be classified as a virtual item, as the management point.

17. The computer-readable portable storage medium according to claim 11, wherein
the management point defines the classification method of the data stored in the database without making the classification method dependent on a particular table and a particular data item in the database.

18. The computer-readable portable storage medium according to claim 11, wherein
the management point is defined by management point information that records a name of the management point and a data type of a data item to which the management point is applied, category information that defines a classification category classified by the management point, and reference value information that defines a numerical value range classified by each classification category.
